(19) United States
(12) Patent Application Publication
(10) Pub. No.: US 2003/0086128 A1
(43) Pub. Date: May 8, 2003

(54) Method to assist in the predictability of open and flexible systems using video analysis

(76) Inventors: Maria Gabrani, Gattikon (CH); Christian Hentschel, Eindhoven (NL); Elisabeth Francisca Maria Steffens, Eindhoven (NL); Reinder Jaap Bril, Eindhoven (NL)

Correspondence Address: U.S. Philips Corporation, 580 White Plains Road, Tarrytown, NY, 10591, US

(21) Appl. No.: 10/277,583

(22) Filed: Oct. 22, 2002

(30) Foreign Application Priority Data
Oct. 25, 2001 (EP) 01204080.4

(51) Int. Cl. H04N 1/04

(52) U.S. Cl. 358/479

(57) ABSTRACT

For an open and flexible system that is robust and cost-effective, it is proposed to use scalable video algorithms (106, 109, 110, 112, 113, 114, 306, 308, 406, 408). Scalable video algorithms (106, 109, 110, 112, 113, 114, 306, 308, 406, 408) can dynamically trade resource usage with visual output quality. In such a system both the visual output quality and the resource usage may change at run-time leading to unpredictable behaviour of the system. A novel approach that assists in the predictability of an open and flexible system is proposed. The idea is that by knowing the parameters that influence the output quality and load of some video algorithms (106, 109, 110, 112, 113, 114, 306, 308, 406, 408), by appropriately measuring them and by providing the necessary information (316, 320, 416, 420, 426, 427) to the system control (321, 421), the system control (321, 421) can react sooner and do the appropriate changes (317, 322, 323, 417, 422, 423), leading to a predictable system.

### FIELD OF THE INVENTION

The present invention relates to a method to assist in the predictability of an open and flexible system, comprising a system, such as a media-processing unit, with at least one video-processing algorithm. The present invention also relates to an apparatus with means to assist in the predictability of an open and flexible system, comprising a system, such as a media-processing unit, with at least one video-processing algorithm. The present invention further relates to the use of a method to assist in the predictability of an open and flexible system, comprising a system, such as a media-processing unit, with at least one video-processing algorithm.

A field of use may be consumer multimedia terminals such as PC, Digital TV sets, STBs, and Displays, or, more general, in media processing units. The consumer multimedia terminals are systems with distinct requirements, namely real-time behaviour, cost-effectiveness, robustness and, what is important in this context, predictability and high output quality.

### BACKGROUND OF THE INVENTION

From patent application WO 94/01824 is known an integrated circuit system based on architecture of Video-Instruction-Set-Computing (VISC). The integrated circuit comprises a plurality of functional units to independently execute the tasks of remote communication, bandwidth adaptation, application control, multimedia management, and universal video encoding. The integrated circuit is also comprised of scalable formatter element connecting to the functional units, which can interoperate arbitrary external video formats and intelligently adapt to selective internal format depending upon the system throughput and configuration. Additionally, there is a smart memory element connecting to the functional units and scalable formatter, which can access, store, and transfer blocks of video data based on selective internal format. In the preferred embodiment, the integrated circuit is also comprised of an embedded RISC or CISC coprocessor element in order to execute DOS, Windows, NT, Macintosh, 0S2, or UNIX applications. In a more preferred embodiment, the integrated circuit includes a real time object oriented operation system element wherein concurrent execution of the application program and real time VISC based video instruction sets can be performed. The present invention is designed to sustain the evolution of a plurality of generations of the VISC microprocessors. These novel VISC microprocessors can be efficiently used to perform wide range of real time distributed video signal processing functions for applications such as interactive video, HDTV, and multimedia communications.

The system is however re-active instead of pro-active when it comes to shortage of resources or overload. Only analysis of pipeline traffic, and not analysis of the source information is done, curing overload conditions ad hoc instead of maintaining control of the overall situation. In a situation where all resources are almost occupied, the system will slow down traffic leading to loss of real-time behaviour. In a worst-case situation, both the visual output quality and the resource usage may change at run-time leading to unpredictable behaviour of the system, possibly requiring re-synchronization.

From patent application WO 00/21302 is known a method and apparatus provided for controlling the quantization level in a digital video encoder that comprises a plurality of parallel compression engines. The input picture is partitioned into a number of panels and each panel is processed by a distinct compression engine. A reference quantizer scale is determined before encoding a frame of video. The reference quantizer scale is used at the first slice of every video image panel being processed by the video encoder. The quantizer scale at the last slice of the image panel is then forced to be the same as the first slice. The forcing step can use a piecewise-linear feedback formula. A group of pictures (GOP) target bit rate is adjusted based on, the number of film pictures and non-film pictures currently in the processing pipeline of at least one of the compression engines. A higher target bit rate is provided for non-film pictures. A buffer level of the video encoder is used to control the start of a new group of pictures (GOP). The start of a new GOP is delayed if the buffer does not have sufficient space to accommodate an intra-coded (I) frame for the new GOP.

The system is however re-active instead of pro-active when it comes to shortage of resources or overload. The start of a new group of pictures is delayed, if a buffer does not have sufficient space, leading to loss of real-time behaviour. In a worst-case situation the system might be unpredictable. The system will skip some of the video information, in order to resume real-time video processing, and possible require re-synchronization. Only analysis of buffer occupation and not analysis of the source information is done, curing overload conditions ad hoc instead of maintaining control of the overall situation.

### SUMMARY OF THE INVENTION

An object of the present invention is to provide a system control that can react sooner and do the appropriate changes, and to provide a robust and predictable system. Another object of the present invention is to enhance the overall output quality at given resources.

This is, as disclosed in claim 1, 3 and 5 achieved according to the invention by that video analysis is performed, and parameters that influence the output quality and load of the at least one video algorithm are measured appropriately, and the necessary information is provided to a system control, and the system control performs the appropriate control and corrections.

Hereby it is insured that the system control can react sooner and do the appropriate control and corrections, leading to a predictable system. As the system control react sooner latency is prevented, i.e. the real-time behaviour of the system is insured. As the system control is doing the control and corrections up-front, bottlenecks are prevented, leading to a predictable system with improved performance. The improved performance secures that complex video processing algorithms can be performed. In addition, the improved performance gain spare time for adding new processing features. In addition the appropriate setting leads to an overall enhanced output quality for given resources.

The basic idea is that by knowing the parameters that influence the output quality and load of some video algorithms and by providing the necessary information to the system control, the system control can react sooner and do the appropriate changes, leading to a predictable system. In addition the appropriate setting (depending on the measured parameters) leads to an overall enhanced output quality for given resources. Hereto, the parameters are measured appropriately.

An embodiment of the method as disclosed in claim 2, has the advantages, that resource usage is dynamically traded with visual output quality. Also the system is more robust and more cost-effective. Combined with the method set forth in claim 1, the 5 unpredictable behaviour arising from the visual output quality and resource usage being changed at run-time, becomes a more predictable behaviour.

An embodiment of the apparatus as disclosed in claim 4, has the advantages, that resource usage is dynamically traded with visual output quality. Also the system is more robust and more cost-effective. Combined with the apparatus set forth in claim 3, the unpredictable behaviour arising from the visual output quality and resource usage being changed at run-time, becomes a more predictable behaviour.

An embodiment of the use as disclosed in claim 6, has the advantages, that resource usage is dynamically traded with visual output quality. Also the system is more robust and more cost-effective. Combined with the use set forth in claim 5, the unpredictable behaviour arising from the visual output quality and resource usage being changed at runtime, becomes a more predictable behaviour.

These and other aspects of the invention will be apparent from and elucidated with reference to the embodiment(s) described hereinafter.

### BRIEF DESCRIPTION OF THE DRAWINGS

FIG. 1 illustrates a typical video-processing path of a consumer multimedia terminal.

FIG. 2 illustrates graphically the output visual quality versus resource usage for various parameter types.

FIG. 3 illustrates an embodiment of a video processing path using measurement modules.

FIG. 4 illustrates another embodiment of a video-processing path using measurement modules.

### DESCRIPTION OF THE PREFERRED EMBODIMENTS

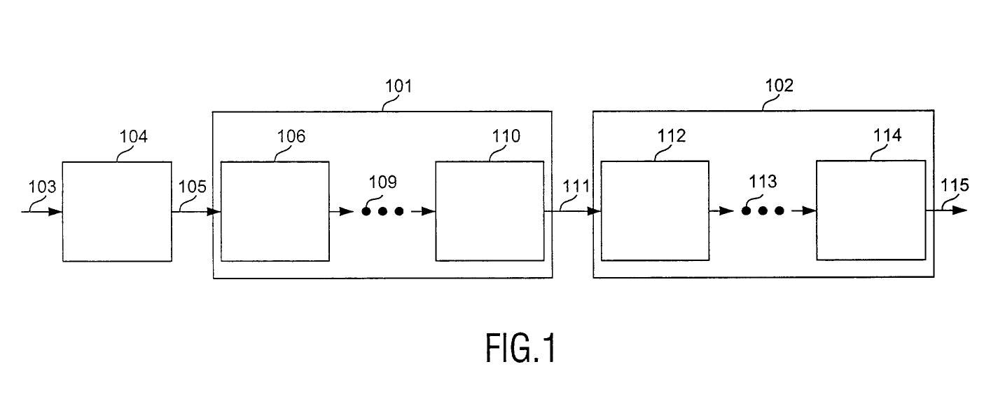

FIG. 1 illustrates a typical video-processing path of a consumer multimedia terminal. An input 103 is fed to a Video Decoding 104. An output 105 of the Video Decoding 104 is passed on to a first Scalable Video Algorithm 106 in a Video Enhancement 101. An output of the first Scalable Video Algorithm 106 is passed through a number of Scalable Video Algorithms 109 to a last Scalable Video Algorithm 110 in the Video Enhancement 101. An output 111 from the Video Enhancement 101 is passed on to a first Scalable Video Algorithm 112 in a Video Output Processing 102. An output of the first Scalable Video Algorithm 112 is passed through a number of Scalable Video Algorithms 113 to a last Scalable Video Algorithm 114 in the Video Output Processing 102. An output 115 from the Video Output Processing 102 is passed out.

Some or all video-algorithms are scalable in the sense, that resource needs for processing are traded against quality. After Video Decoding 104, the information is passed through some Scalable Video Algorithms 106, 110 for video enhancement. Then the information is passed through some Scalable Video Algorithms 112, 114 for video output processing. The scalable video algorithms 106, 110, 112, 114 are able to dynamically trade resource usage with visual output quality. In this example no output from the Video Decoding 104 or any of the Scalable Video Algorithms 106, 110, 112, 114 are provided for an overall control, such as a system control module, in order to correct for overload conditions, possibly leading to an unpredictable system.

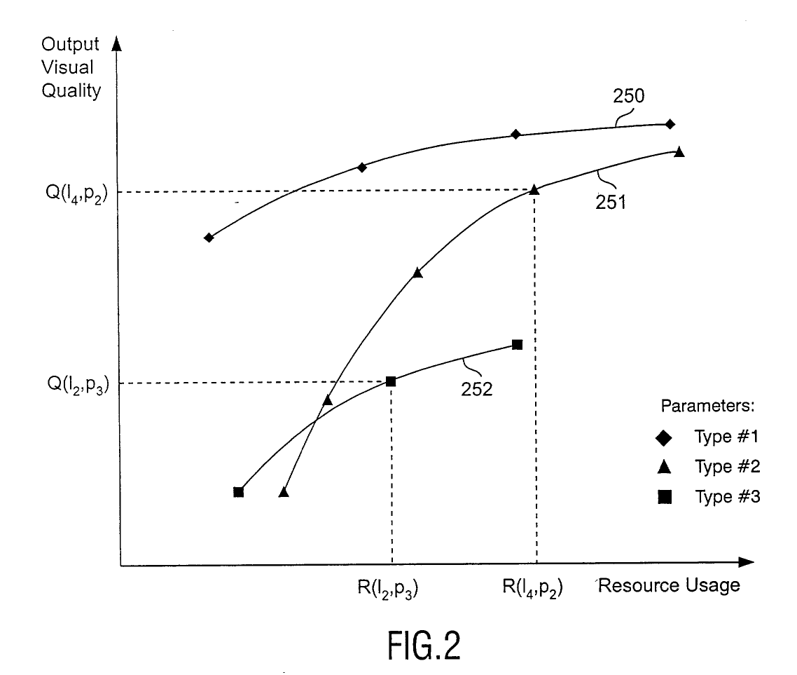

FIG. 2 is a graphical illustration of the quality levels, i.e. the tuples of output visual quality and resource usage, attained with a Scalable Video Algorithm (SVA) for different parameters. R(lᵢ, pⱼ) stands for the resource usage of the SVA, when the quality assigned is lᵢ, and the parameters are of type pⱼ. Q(lᵢ, pⱼ) stands for the output visual quality attained when the quality assigned is lᵢ and the parameters are of type pⱼ. A curve 250 illustrates the relation between Output Visual Quality and Resource Usage for Parameters of a type 1. A curve 251 illustrates the relation between Output Visual Quality and Resource Usage for Parameters of a type 2. A curve 252 illustrates the relation between Output Visual Quality and Resource Usage for Parameters of a type 3.

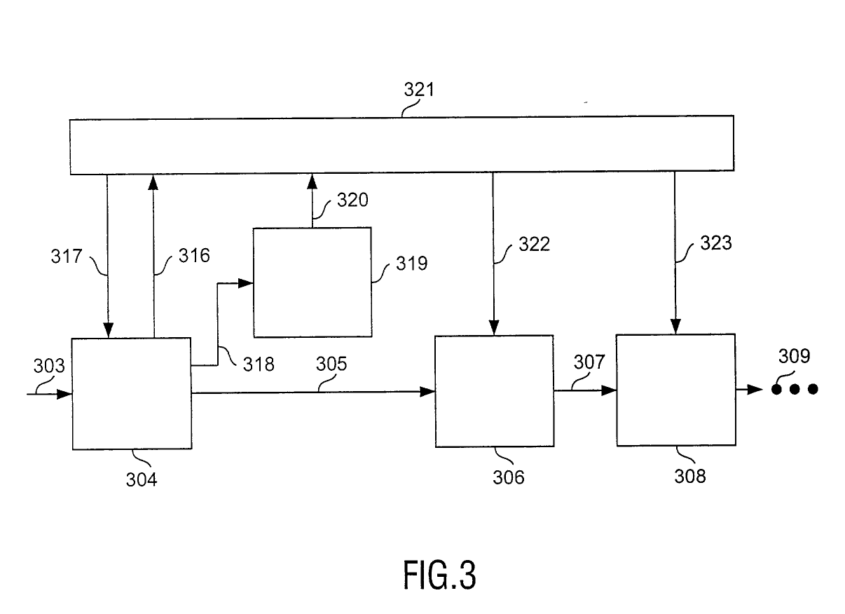

FIG. 3 illustrates a preferred embodiment of a video-processing path using measurement modules. An input 303 is fed to a Video Decoding 304. An output 305 of the Video Decoding 304 is passed on to a first Scalable Video Algorithm 306, and an output 318 of the Video Decoding 304 is passed on to a Video Analysis 319. An output 320 of the Video Analysis 319 is passed on to a System Control 321. An output 307 from the first Scalable Video Algorithm 306 is passed on to a next Scalable Video Algorithm 308. An output 309 from the next Scalable Video Algorithm 308 is passed on, possibly to one or more Scalable Video Algorithms, and/or possibly out. An output 316 from the Video Decoding 304 is passed on to the System Control 321. An output 317 from the System Control 321 is passed on to the Video Decoding 304. An output 322 from the System Control 321 is passed on to the first Scalable Video Algorithm 306. An output 323 from the System Control 321 is passed on to the next Scalable Video Algorithm 308. Similar subsequent outputs from the System Control 321 can be passed on to subsequent Scalable Video Algorithms; this is not indicated on FIG. 3.

FIG. 3 illustrates a proposed video-processing path using measurement modules. More than one video analysis block with different properties may be used at different locations. The Video Decoding 304 and Video Analysis 319 modules estimates the status of the parameters that influence the load and output visual quality of the Scalable Video Algorithms 306, 308 in the system, and informs via parameters 316, 320 the System Control 321 to (re)act appropriately, i.e. by the control 322, 323 of the Scalable Video Algorithms 306, 308. The system therefore becomes robust and predictable.

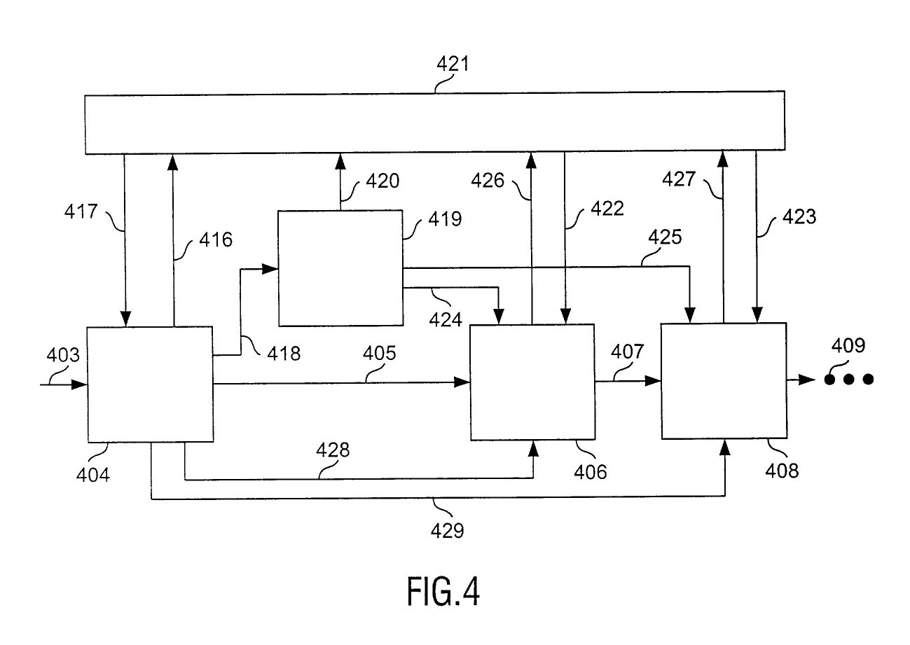

FIG. 4 illustrates another preferred embodiment of a video-processing path using measurement modules, which is also the best mode of the invention. An input 403 is fed to a Video Decoding 404. An output 405 of the Video Decoding 404 is passed on to a first Scalable Video Algorithm 406, and an output 418 of the Video Decoding 404 is passed on to a Video Analysis 419. Possibly, an output 420 of the Video Analysis 419 is passed on to a System Control 421. An output 407 from the first Scalable Video Algorithm 406 is passed on to a next Scalable Video Algorithm 408. An output 409 from the next Scalable Video Algorithm 408 is passed on, possibly to one or more Scalable Video Algorithms, and/or possibly out. An output 416 from the Video Decoding 404 is passed on to the System Control 421. An output 417 from the System Control 421 is passed on to the Video Decoding 404. An output 422 from the System Control 421 is passed on to the first Scalable Video Algorithm 406. An output 423 from the System Control 421 is passed on to the next Scalable Video Algorithm 408. Similar subsequent outputs from the System Control 421 can be passed on to subsequent Scalable Video Algorithms; this is not indicated on FIG. 4. An output 424 from the Video Analysis 419 is passed on to the first Scalable Video Algorithm 406. An output 425 from the Video Analysis 419 is passed on to the next Scalable Video Algorithm 408. An output 426 from the first Scalable Video Algorithm 406 is passed on to the System Control 421. An output 427 from the next Scalable Video Algorithm 408 is passed on to the System Control 421. An output 428 from the Video Decoding 404 is passed on to the first Scalable Video Algorithm 406. An output 429 from the Video Decoding 404 is passed on to the next Scalable Video Algorithm 408.

FIG. 4 illustrates another proposed video-processing path using measurement modules. The Video Decoding 404 and Video Analysis 419 modules estimates the status of the parameters that influence the load and output visual quality of the Scalable Video Algorithms 406, 408 in the system, and inform via parameters 424, 425, 428, 429 the Scalable Video Algorithms 406, 408, which in turn inform 426, 427 the System Control 421 to (re)act appropriately, i.e. by the control 422, 423 of the Scalable Video Algorithms 406, 408. Possibly the Video Decoding 404 and Video Analysis 419 modules also inform 416, 420 the System Control 421 to (re)act appropriately. The system therefore becomes robust and predictable.

It should be noted that the ideas set forth also applies for mixed systems, i.e. systems where only some of the video algorithms can be controlled from a system control. Also some non-scalable video algorithms can be controlled from a system control. The ideas set forth therefore applies for controllable video algorithms in general.

In the following focus will be on the predictability property of consumer terminals, and the effect of the video processing algorithms to this property.

The predictability of a consumer terminal is challenged in cases of overload of the video processing algorithms. Such overloads can occur during scene changes or due to statistical variations of certain parameters of the video processing algorithms, such as motion or details. Currently, most video processing algorithms are implemented in dedicated hardware, to handle worse case needs of the video algorithms.

Current trends ask for flexibility and open systems, and thus for video processing algorithms running on programmable components. Programmable components, however, are very expensive in silicon area and power consumption compared to dedicated hardware. Therefore, the design and management of the system should be done in a way that satisfies cost-effectiveness.

The use of scalable video algorithms (SVAs), that are able to exchange resources for output quality in a quality of service (QoS) environment, is proposed. SVAs are controlled at run-time in their resource and quality behaviour. A set of SVAs in a modular form can perform the different applications needed in a multimedia PC, set-top box, TV set, or, more general, in media processing units.

In a consumer multimedia terminal, the various video input streams are typically decoded (channel, source/colour decoding), enhanced (noise and artefact reduction, scaling, scan rate conversion, edge enhancement) and finally either rendered for display (mixing, colour stretching, YUV-to-RGB, video and graphics blending), or encoded for storage or further transmission. Each of these parts of the video-processing path consists of a cluster of video processing algorithms as indicated on FIG. 1. Some of them can be scalable.

Scalable video algorithms are designed in different con-figurations to allow a trade-off between resource usage and visual output quality. Each one of these configurations 1 is described by a tuple of resource usage and output visual quality, (R(1), Q(1)), and is called quality level.

In a resource adaptive system, the system control assigns to each SVA a quality level, according to the available resources. The quality level of each SVA is the outcome of an optimisation process whose criterion is to optimise both the visual output quality and the resource usage. During the optimisation, the search space includes all the appropriate quality levels of each SVA. The system control performs this optimisation every time there is a change in the system.

However, the performance (output visual quality and load) of several video algorithms may depend on a number of parameters, such as certain contents of the video stream, the output size or the user focus. For example, the peaking algorithm may use noise adaptive techniques that influence both its resource requirements and its output visual quality. Therefore, the set of valid quality levels for the peaking algorithm is different with or without the presence of noise. Another example is the user focus specification. The same algorithm may support a different set of quality levels when high quality is required (user focus) and when lower quality is expected (non user focus). Hence, the same algorithm may support more than one set of valid quality levels depending on a number of predefined parameters as indicated on FIG. 2. These sets of valid quality levels are called quality mappings.

What the previous paragraph suggests is that for optimal quality level assignments the system control should have, each time, the valid set of quality levels for each algorithm, i.e., the appropriate quality mapping. By having the system control the valid set of quality levels the most appropriate resource allocations are made and thus the most robust and predictable the system becomes.

Moreover, the system control allocates resources to SVAs (assigns quality levels) based on average to worse case resource needs, allowing this way more applications to run concurrently, and thus improving the cost-effectiveness of the system. However, the load of some algorithms is sensitive to some data parameters, such as details. If the load of an SVA is higher than initially claimed, then the system control may react by reducing the quality level of this (or some other less important) SVA.

However, such (re)action from the system control follows the overload detection and thus requires some time, during which the behaviour of the system may be non-optimal, e.g., the SVAs may run behind. The earlier the overload is detected the faster the system control performs the appropriate changes, and thus the more predictable the system becomes. Therefore, it is desirable to provide means of early detection of overload situations. Such a responsibility is usually the work of the system control via a monitoring module.

A method that assists in the predictability of the system by using information from the video signals is proposed. The proposed approach identifies the parameters that may cause load and/or output visual quality changes and provides the system control with the necessary information. The system then performs optimisation using the appropriate quality mappings for each SVA.

Moreover, the proposed method assists in overload protection by appropriately notifying the system early enough. The method and its implications to the system and the video processing chain is described in the following.

As already mentioned, the load and/or the output visual quality of some video algorithms is sensitive to certain parameters, such as motion, details, noise, focus and window size. The value or type of these parameters may change, for example, in a scene change, due to statistical variations or after a user request, challenging the systems behaviour. The scalable video algorithms can assist in the predictability of the system the following way.

First, the algorithm designer should identify the parameters whose (statistical) variation affects the performance (resource needs and output visual quality) of the algorithm. The algorithm designer should also define the appropriate quality mappings of the algorithm, as indicated on FIG. 2. That is, for every type or value pⱼ of the parameter p, he should provide the set of valid quality levels (R(l, pⱼ), Q(l, pⱼ)), 1=1, . . . , Nⱼ, and j fixed as indicated on FIG. 2.

During initialisation of the system, this information should be provided to the system control via the scalable video algorithm control part.

In the video-processing path software modules are identified and/or introduced that measure the (statistical) variation of the parameters p. These software modules for measurement may be distributed in the system. The best location for measurement is before the algorithms that are sensitive to them. Such modules include the noise measurement, motion estimation, frequency range measurement, and scene cut detection. The measurement modules inform the system control about changes in the state (e.g. value or type) of the respective parameters, alerting the system for overload situations before they actually occur.

The system control can thus start early enough the necessary procedure i.e., rearrange the available resources to the running applications in a new optimal way, and most importantly using the appropriate quality mapping for each SVA.

The earlier the measurements in the processing chain, the earlier the system may perform the necessary changes, and the more predictable the system becomes, both in resource usage and in output quality.

In case of MPEG input stream, estimates of the statistical variation of some parameters can be performed during video decoding, e.g., for motion. For the rest of the cases (e.g. noise), in the video processing path software modules that measure the (statistical) variation of the parameters can be introduced.

The video algorithms whose load is sensitive to parameters like the above (e.g. noise) are usually part of the video enhancement, as indicated on FIG. 1. To that end using the video processing chain of FIG. 3 is proposed. In the proposed chain a new software module is introduced, the Video Analysis whose purpose is to perform analysis to its input (decoded) video stream, detect the parameter changes that may lead to overloads, and inform the system control appropriately.

The concept of having measurements modules in the video-processing path to assist in the selection of appropriate working modes for some video processing modules is known (e.g. Auto-TV). The difference with the current solutions is two-fold. First, to use the measurement modules to assist the system control in selecting the appropriate, at each time, set of valid quality levels, is proposed in order to perform optimal resource (re)allocation. Second, the measurement modules are placed at an early point in the processing path. This is done in order to have an early information about image or sequence characteristics and changes in the system, and thus allow the system control to react sooner. The information used is obtained either from the video decoding, or the video analysis modules. The video analysis is introduced for estimating the parameters that the video-decoding module cannot estimate.

The introduction of the video analysis module may lead to increase of the path latency and to reduction of available resources for the rest of the applications. However, the amount of resources required for its execution can be small. Moreover, its overall contribution to the robustness and predictability of the system overrules the above limitations.

Another way to use the proposed approach is shown in FIG. 4. The parameter information is sent (broadcasted) to the SVAs and they may send the appropriate information to the system control. This approach makes the functionality of the system control a little easier, without losing the time advantage of the previous approach; still the appropriate information for the system optimisation are given to the system control before the change in the SVAs actually occurs.

Key inventive steps of the present invention can be summarised as follows:

1. The performance (load and output visual quality) of some video processing algorithms is sensitive to certain parameters, such as motion, details, noise, user focus and window size. Hence, the same scalable video algorithm may support more than one set of valid quality levels (quality mappings) depending on the value or type of a (number of) predefined parameter(s) (FIG. 2).

2. The scalable video algorithms can assist in the predictability of a system, by providing to the system control the type of parameters that influence their performance, and the respective quality mappings.

3. In order the system control to perform the optimal resource allocation, it should consider the appropriate quality mapping at each time and of each SVA.

4. To define the appropriate quality mapping at each time, the value or type of sensitivity parameters of each SVA should be estimated.

5. The statistical behaviour of these parameters over time can be partly measured in the video decoding module (in case of MPEG input data) and/or the video analysis module. The measurements/estimates can be reported to the system control.

6. The system control is notified for which parameters are changed and thus which SVAs are influenced and which are the appropriate quality mappings for each SVA that should be considered in the system optimisation process (re)allocation of resources. By having the system control the valid set of quality levels the most appropriate resource allocations are made and thus the most robust and predictable the system becomes.

7. An additional functionality may be overload prevention. Having the video analysis module as early as possible in the video processing path the sooner the system control is notified, and the faster can start the necessary changes to avoid overloads (FIG. 3). This way, the system control may be informed about overload situations before they actually occur.

8. The most appropriate position of the video analysis module is shown in FIG. 3. This position corresponds to the earliest point of the path that the decoded video input stream is available.

1. A method to assist in the predictability of an open and flexible system, comprising a system, such as a media processing unit, with at least one video processing algorithm (106, 109, 110, 112, 113, 114, 306, 308, 406, 408), characterized in that video analysis (319, 419) is performed, and parameters that influence the output quality and load of the at least one video algorithm (106, 109, 110, 112, 113, 114, 306, 308, 406, 408) are measured appropriately, and the necessary information (316, 320, 416, 420, 426, 427) is provided to a system control (321, 421), and the system control (321, 421) performs the appropriate control and corrections (317, 322, 323, 417, 422, 423).

2. A method to assist in the predictability of an open and flexible system according to claim 1, characterized in that said video processing algorithms (106, 109, 110, 112, 113, 114, 306, 308, 406, 408) are scalable video algorithms dynamically trading resource usage with visual output quality.

3. An apparatus with means (316, 317, 318, 319, 320, 321, 322, 323, 416, 417, 418, 419, 420, 421, 422, 423, 424, 425, 426, 427, 428, 429) to assist in the predictability of an open and flexible system, comprising a system, such as a media processing unit, with at least one video processing algorithm (106, 109, 110, 112, 113, 114, 306, 308, 406, 408), characterized in that video analysis (319, 419) is performed, and parameters that influence the output quality and load of the at least one video algorithm (106, 109, 110, 112, 113, 114, 306, 308, 406, 408) are measured appropriately, and the necessary information (316, 320, 416, 420, 426, 427) is provided to a system control (321, 421), and the system control (321, 421) performs the appropriate control and corrections (317, 322, 323, 417, 422, 423).

4. An apparatus with means (316, 317, 318, 319, 320, 321, 322, 323, 416, 417, 418, 419, 420, 421, 422, 423, 424, 425, 426, 427, 428, 429) to assist in the predictability of an open and flexible system according to claim 3, characterized in that said video processing algorithms (106, 109, 110, 112, 113, 114, 306, 308, 406, 408) are scalable video algorithms dynamically trading resource usage with visual output quality.

5. The use of a method to assist in the predictability of an open and flexible system, comprising a system, such as a media processing unit, with at least one video processing algorithm (106, 109, 110, 112, 113, 114, 306, 308, 406, 408), characterized in that video analysis (319, 419) is performed, and parameters that influence the output quality and load of the at least one video algorithm (106, 109, 110, 112, 113, 114, 306, 308, 406, 408) are measured appropriately, and the necessary information (316, 320, 416, 420, 426, 427) is provided to a system control (321, 421), and the system control (321, 421) performs the appropriate control and corrections (317, 322, 323, 417, 422, 423).

6. The use of a method to assist in the predictability of an open and flexible system according to claim 5, characterized in that said video processing algorithms (106, 109, 110, 112, 113, 114, 306, 308, 406, 408) are scalable video algorithms dynamically trading resource usage with visual output quality.
